(19) United States
(12) Patent Application Publication
(10) Pub. No.: US 2012/0020483 A1
(43) Pub. Date: Jan. 26, 2012

(54) SYSTEM AND METHOD FOR ROBUST AUDIO SPATIALIZATION USING FREQUENCY SEPARATION

(76) Inventors: Sachin G. Deshpande, Camas, WA (US); Scott J. Daly, Kalama, WA (US)

(21) Appl. No.: 12/842,922

(22) Filed: Jul. 23, 2010

(51) Int. Cl. H04R 5/00

(52) U.S. Cl. 381/28

(57) ABSTRACT

Systems and devices for, and methods of, frequency separation and spatialization of audio content, by: (a) filtering a stream content; (b) transmitting the filtered stream content via a plurality of speaker channels, wherein at least one of the speaker channels of the plurality of speaker channels comprises an amplitude gain based on a display position set; and optionally (c) generating an inversion of the filtered stream content; and (d) combining the inverted filtered stream content with the stream content to generate a low frequency component of the audio content.

### TECHNICAL FIELD

Embodiments pertain to systems and devices for, and methods of, frequency separation and transmission of audio content associated with a display.

### BACKGROUND

Frequency separation has been applied to differentially boost the frequency bands. A graphic equalizer using software or hardware equalizers is commonly used to achieve frequency band boosting and/or attenuating. A graphic equalizer typically includes a number of sliders which can be individually controlled to effect a boost or to attenuate different frequency ranges of an original sound, and do so differently from one another.

The frequency separation done by graphic equalizers allows audio tuning for a consumer preference. In some cases, consumers may utilize graphic equalizers to boost or attenuate certain frequency bands to suit their personal taste. For example, some consumers may prefer a bass boost. In other cases, a music creator may use equalizers to alter frequency bands differently for creating various effects. For example, equalization is often used to manipulate the timbre of musical instruments.

### SUMMARY

Systems and devices for, and methods of, frequency separation and transmission of audio content, by for example, a method that may include the steps of: (a) filtering a stream content; and (b) transmitting the filtered stream content via at least one or a plurality of speaker channels, where at least one of the speaker channels of the plurality of speaker channels comprises an amplitude gain based on a display position set, e.g., based on the display of an associated audiovisual (AV) window within a display field of a display. Method embodiments may further comprise: (c) generating an inversion of the filtered stream content; (d) combining the inverted filtered stream content with the stream content; and (e) transmitting the combination of the inverted filtered stream content and the stream content. Some embodiments may include the step of: receiving, reading, and/or accessing a source audio stream content. In some embodiments, the method may include the step of transmitting the filtered stream content, where the stream content comprises audio content and the transmitted filtered stream content comprises high frequency stream content. Optionally, the high frequency stream content may be transmitted to one or a plurality of loud speakers proximate to a video display, where the transmission of the high frequency stream content to the plurality of loud speakers may be based on the state of the video display, e.g., the position of the associated AV window on the display field relative to loud speakers. Optionally, the transmitted combination of the inverted filtered stream content and the stream content is a low frequency stream content of the stream content. In other embodiments, the low frequency stream content may be transmitted to a loud speaker and optionally to an omni-directional speaker. In another embodiment, the one or more output channels may be stored into a custom file format.

A computing device embodiment may comprise (a) a processor, and (b) a memory comprising a set of amplitude gains associable with a display position set; where the processor is configured to (a) filter a stream content; (b) transmit the filtered stream content via a plurality of speaker channels, where at least one of the speaker channels of the plurality of speaker channels comprises an amplitude gain based on a display position set; and may optionally be configured to (c) generate an inversion of the filtered stream content; (d) combine the inverted filtered stream content with the stream content; and (e) transmit the combination of the inverted filtered stream content and the stream content. In some embodiments, the device may be configured to perform at least one of: receiving, reading, and/or accessing a source audio stream content. In some embodiments, the device may be further configured to perform the step of transmitting the filtered stream content, where the stream content comprises audio content and the transmitted filtered stream content comprises high frequency stream content. Optionally, the high frequency stream content may be transmitted to a plurality of loud speakers proximate to a video display, where the transmission of the high frequency stream content to the plurality of loud speakers may be based on the state of the video display, e.g., the position of the AV window associated with the high frequency stream content that is high frequency audio content, i.e., the relative disposition of the AV window in the display field, particularly relative to loud speakers. Optionally, the transmitted combination of the inverted filtered stream content and the stream content is a low frequency stream content of the stream content. In other embodiments, the low frequency stream content may be transmitted to a loud speaker and/or optionally to an omni-directional speaker. In another embodiment, the output channels may be stored into a custom file format.

A computer-readable non-transitory medium embodiment may have computer-executable instructions stored thereon which, when executed by a computer, configure the computer to: (a) filter a stream content; (b) transmit the filtered stream content via a plurality of speaker channels, wherein at least one of the speaker channels of the plurality of speaker channels comprises an amplitude gain based on a display position set; and may optionally configure the computer to (c) generate an inversion of the filtered stream content; (d) combine the inverted filtered stream content with the stream content; and (e) transmit the output of the combination of the inverted filtered stream content and the stream content.

### BRIEF DESCRIPTION OF THE DRAWINGS

Embodiments are illustrated by way of example and not limitation in the figures of the accompanying drawings, and in which:

FIG. 1 is a functional block diagram depicting an exemplary process of a single channel frequency separation-content generation stage;

FIG. 2 illustrates an exemplary top level functional block diagram of a computing device embodiment of the present invention;

FIG. 3 is a flowchart diagram depicting an exemplary process of an audio spatialization system or device using frequency separation;

FIG. 4A is a functional block diagram depicting an exemplary process of an on-display audio spatialization based on the associated AV window positioning;

FIG. 4B shows an exemplary AV window on a display which is positioned so that the plurality of speakers may utilize a virtual sound positioning based on gain control.

FIG. 4C shows another exemplary AV window on a display which is positioned so that the plurality of speakers may utilize a virtual sound positioning based on gain control.

FIG. 5 is an exemplary functional block diagram depicting a multi-channel frequency separation-content generation stage and a down-mixer;

FIG. 6A is an exemplary functional block diagram depicting a multi-channel frequency separation-content spatialization system using content storage;

FIG. 6B is an exemplary functional block diagram depicting a multi-channel frequency separation-content spatialization system using content storage and a down-mixer;

FIG. 7 is a flowchart depicting an exemplary process of a spatialization system or spatialization device using frequency separation and content storage;

FIG. 8 is a flowchart depicting an exemplary process of a spatialization system or spatialization device using frequency separation;

FIG. 9 is a graph showing the frequency response of two exemplary bass separation filters;

FIG. 10 shows the amplitude plot for an original stereo content with two audio channels (left and right);

FIG. 11 shows the amplitude plot for the bass frequencies of the audio channels content;

FIG. 12 shows the amplitude plot for the non-bass frequencies of the audio channels content; and

FIG. 13 shows a custom WAV file, created from the original stereo stream content where the file contains twice the number of tracks of the original content file.

### DETAILED DESCRIPTION

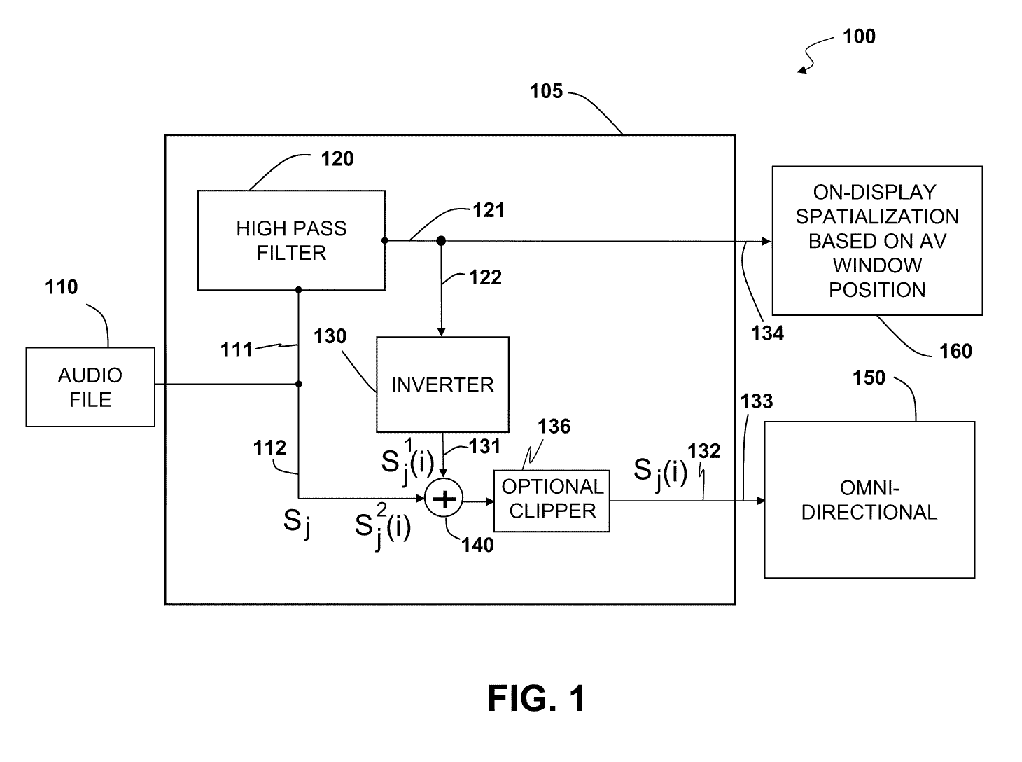

FIG. 1 is an exemplary functional block diagram depicting an embodiment of a frequency separation and audio content spatialization system 100. Embodiments of the frequency separation stage 105 may be executed in real time or near real time, and the audio source may be received, read, or accessed from an original audio source 110. The original audio source 110 may be received by the frequency separation stage 105 as a stream content, e.g., an audio file, and may be optionally replicated into a plurality of audio stream contents, e.g., a first stream content 111 and a second stream content 112. The first stream content 111 may be passed through a high pass filter 120 producing a filtered stream content 121 or otherwise be subjected to high pass filtering. The filtered stream content 121 may be replicated or referenced as a second filtered stream content 122. The first filtered stream content 121 may be transmitted 134 from the frequency separation stage 105 to a plurality of loud speakers and emanated as a function of the state of the video on the display 160, e.g., channel gains may be varied based on the location of an associated AV window relative to the perimeter of the display and/or the location of two or more loud speakers associated with the display. A second filtered stream content 122 is depicted as being passed through an inverter 130 producing a negatively signed version of the second filtered stream content 131, which is depicted as being added, using an adder 140, to the second stream content 112 to generate a low frequency stream content 132—by nullifying the high frequency content of the second stream content. The low frequency stream content 132 may then be transmitted 133 to a loud speaker, and may then be emanated from a source point omni-directionally 150.

In an embodiment, the stream content may be at least one of an audio stream, a video stream, or in some combination of audio and video stream content. In some embodiments the bass frequencies may be completely removed when the stream content is passed through the high pass filter—while in other embodiments, the bass frequencies may be substantially removed. The high pass filter generally attenuates frequencies lower than the filter's cutoff frequency, and exemplary embodiments include the cutoff frequency for the bass filter in a range of 250 Hz and/or 400 Hz.

In an embodiment of the high pass filter, the filter has a memory. A filter with memory may eliminate the need to replicate the audio stream content being passed through it. In an embodiment where the filtering is destructive of the input, replicating or storing the stream content may be optionally executed outside the filter. Filtering may be done, but is not limited to, using a time domain digital filter or a frequency domain filter, e.g., such as a Fast Fourier Transform (FFT) filter of a discreet Fourier Transform, a bandwidth elimination step, and then an Inverse FFT for the inverse discreet Fourier Transform.

The inverter of the exemplary audio sample inversion operation flips the sign of the audio sample while keeping the magnitude the same. The inversion may be implemented using the subtraction method or optionally by way of negation. The inversion operation in FIG. 1 can be represented as:

for i = 1 : N
Sⱼ(i) = −Sⱼ(i)
end

Where Sⱼ(i) is the audio sample magnitude for j'th audio channel for the i'th sample (with i=1, . . . , N).

The adder adds the two inputs to create a final output. Optionally, a signal clipper 136 may be applied to the output. The adder operation with the signal clipping 136 may be represented as:

for i = 1 : N
Sⱼ(i) = CLIP(Sⱼ¹(i) + Sⱼ² (i))
end

Where Sⱼ¹(i) and Sⱼ²(i) are the two input audio magnitudes related to j'th audio channel for the i'th sample (with i=1, . . . , N) and CLIP(_) represents the optional clipping operation of the signal clipper 136. The optional clipping may be applied in embodiments where noise has been introduced into the stream content. For example, in an embodiment where content storage is utilized, compression of data while storing may introduce errors, e.g., quantization or rounding errors, and therefore clipping may be implemented in order to address overflow.

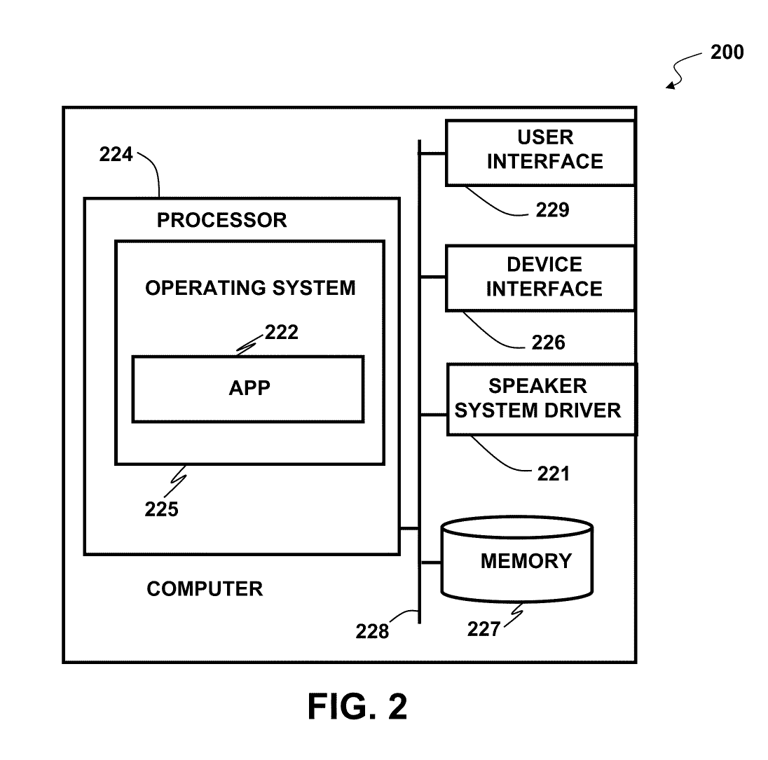

FIG. 2 is a functional block diagram of an exemplary computer 200 having a processor 224, such as a central processing unit (CPU), addressable memory 227 addressable via a data bus 228, an external device interface 226, e.g., an optional universal serial bus (USB) port and related processing, and/or an Ethernet port and related processing, a user interface 229, and a speaker system driver interface 221. The processor 224 may be configured to execute programmed steps via an operating system 225, e.g., a real time operating system, where the steps that comprise the application 222 may include an audio frequency separation operation and spatialization, storing the audio frequency, and transmitting the spatialized and omni-directional sounds to a speaker system driver 221.

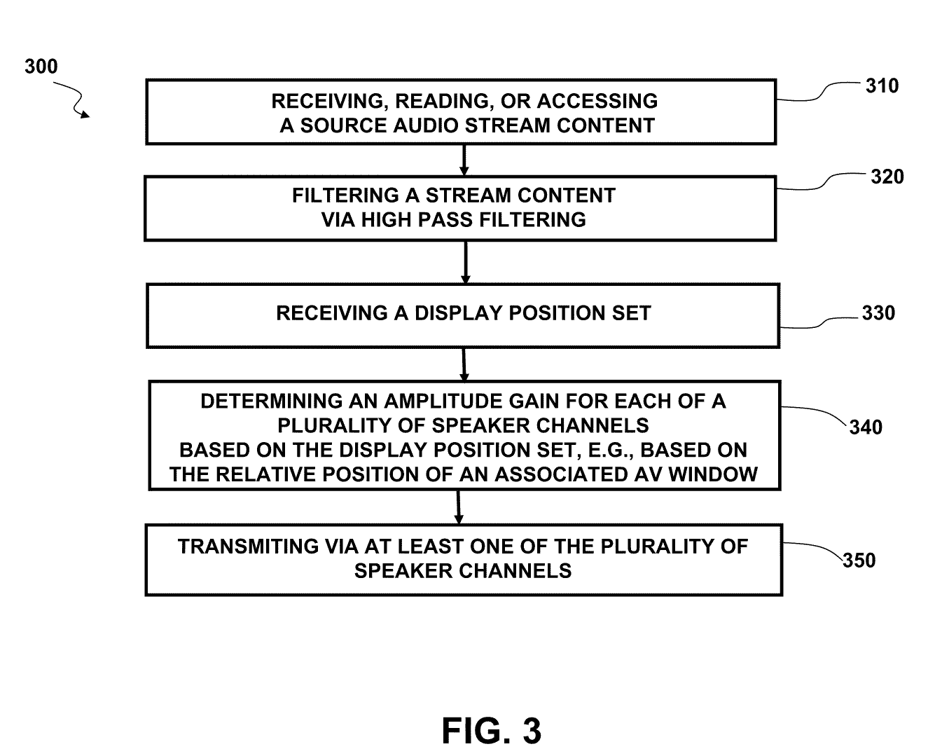

FIG. 3 depicts a flowchart of an exemplary process 300 of the audio spatialization and frequency separation system. The source audio stream content (step 310) is depicted as provided to the system or device by optionally receiving, reading and/or accessing the original audio content. The audio stream content may be passed through a high pass filter (step 320) or otherwise subjected to high pass filtering or low frequency attenuation. For example, a bass removal filter which passes, i.e., allows through, the high frequency stream content. A display position set is received (step 330), e.g., position of the audiovisual (AV) window that for example is associated with the filtered audio stream content. The amplitude gain for at least one and in some embodiments each of a plurality of speaker channels, based on the display position set, is determined (step 340). The high frequency stream content based on the amplitude gain is then transmitted via each of the plurality of speaker channels (step 350).

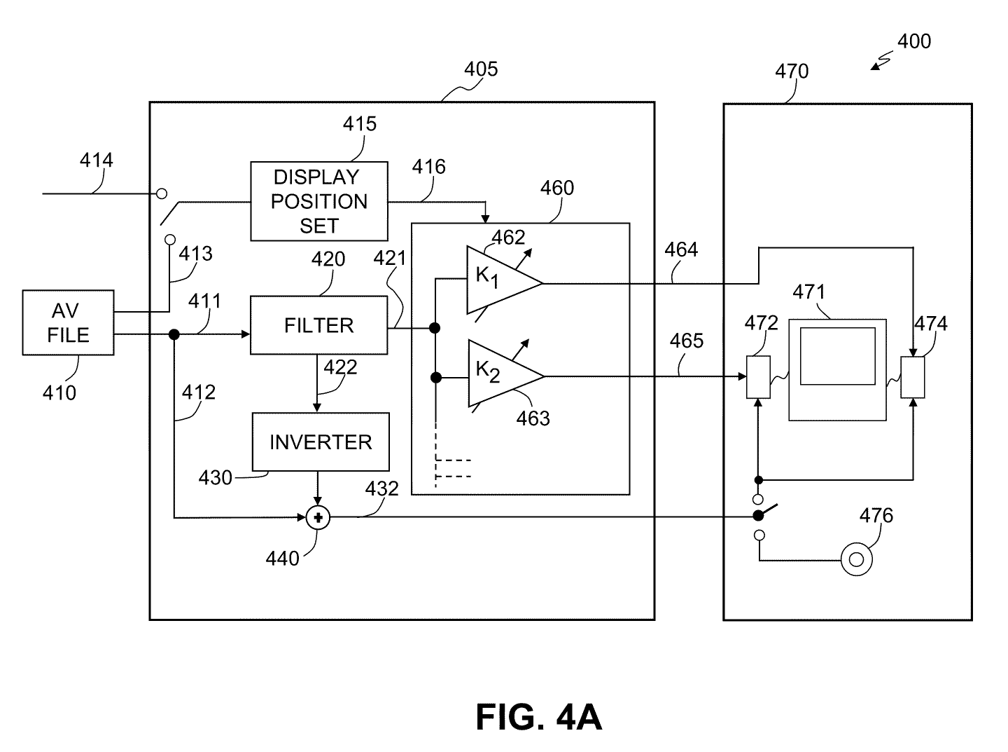

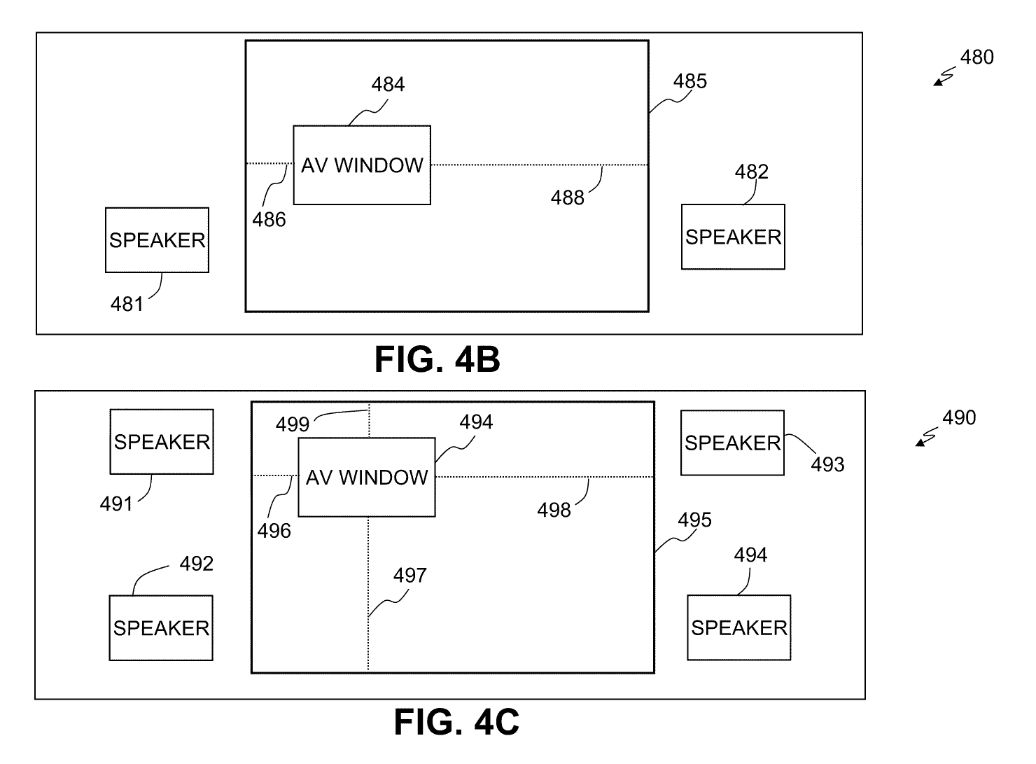

FIG. 4A is an exemplary functional block diagram depicting an exemplary embodiment of an on-display spatialization of a high frequency stream content based on an associated AV window position 400. This embodiment is depicted as applying virtual sound positioning based on gain control 405, where a display position set may be received, read or accessed from an original audiovisual source 410 or an independent source 414. The audiovisual source 410, e.g., audiovisual file, is depicted as having a stream content 411, and optionally the display position set content 413. The first stream content 411 may be passed through a high pass filter 420 or otherwise subjected to high frequency filtering to produce a filtered stream content 421 that may comprise audio stream content. In the embodiment where a display position set information 416 is provided, the information may be provided to a virtual sound positioning module 460. The virtual sound positioning module 460 is depicted as receiving the filtered stream content 421, and then based on the display position set 415, the module 460 determines or varies the gain for at least one and in some embodiments each filtered stream content channel. A set of one or more variable gains 462, 463 represents the gain control for each channel based on the display position set 415, and effect a varying volume intensity of monaural sound being transmitted. Using the variables K₁, K₂, . . . Kₙ the amplitude on each channel, 1-n, is controlled to where the corresponding speaker channels 472, 474 will receive stream contents 464, 465 based on the display position 471 of the display position set 415, e.g., information contained in the display. In this embodiment, a second filtered stream content 422 is depicted as being passed through an inverter 430 the output of which is then added, using an adder 440, to a second stream content 412 to generate a low frequency stream content 432, in this example, by negating the high frequency content of the second filtered stream content 422. The monaural low frequency stream content 432 may then be transmitted to a loud speaker 476 or optionally it may then be transmitted for emanation from the set of two or more speakers, directionally or omni-directionally.

FIG. 4B is a diagram depicting an exemplary embodiment of a spatialized system 480 with two speakers, e.g., a left speaker 481 and a right speaker 482. In this embodiment, the AV window 484 on the display 485 is depicted as positioned at a distance X₁ 486 and X₂ 488 on an axis. The on-display spatialization based on an AV window 484 position may control the gain of the speakers in such a fashion so that the left speaker 481 will emanate a higher intensity volume of the monaural sound being transmitted to the speakers. For example, the left speaker 481 closest to the AV window will have a higher intensity volume than the right speaker 482 farther away. In this embodiment, sound is emanated from a plurality of speakers 481, 482 based on the AV window 484 position, wherein the spatialization is effectively apportioning the sound via amplitude gain control.

FIG. 4C is a diagram depicting an exemplary embodiment of a spatialized system 490 with four speakers, e.g., an upper left speaker 491, a lower left speaker 492, an upper right speaker 493, and a lower right speaker 494. In this embodiment the AV window 494 on the display 495 is positioned a distance X₁ 496 and X₂ 498 on one axis and Y₁ 497 and Y₂ 499 on another axis. The on-display spatialization based on an AV window 494 position may control the gain of the speakers in such a fashion so that the left upper speaker 491 and left lower speaker 492 will emanate a higher intensity volume of the monaural sound being transmitted to the speakers than the right upper speaker 493 and the right lower speaker 494. That is, the left speakers 491, 492 which are depicted as closest to the AV window 494 will have a higher intensity volume than the right speakers 493, 494 which are depicted as farther away from the AV window 494. The left upper speaker 491 is closet to the AV window 494 and so the left upper speaker 491 may in turn have a higher gain than the left lower speaker 492. In this embodiment, sound may be emanated from a plurality of speakers 491-494 based on the AV window 494 position, where the spatialization is done by effectively apportioning the sound via amplitude gain control. A plurality of speakers may be used to exemplify this setup.

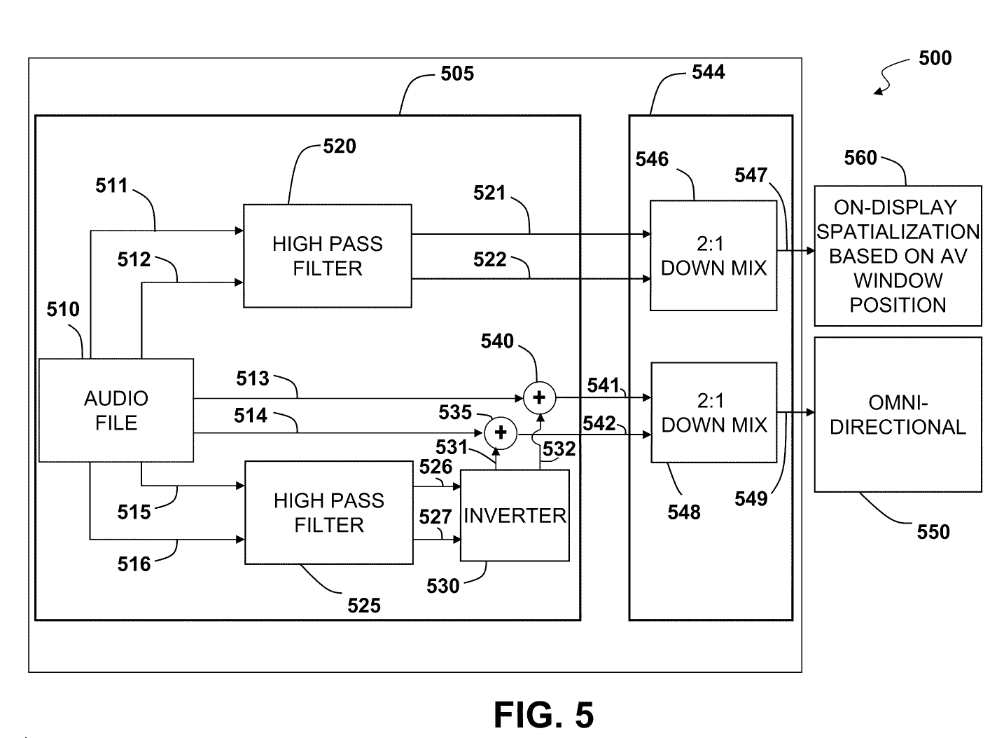

FIG. 5 depicts in an exemplary functional block diagram a multiple channel, e.g., left and right channel, frequency separation-content generation and down mixing stage 500. The down-mixer may be included where a number of distinct audio channels are mixed together to produce a lower number of channels. Down-mixing may be executed at various ratios, e.g., at a 2:1 ratio. The frequency separation-content generation stage 505 may receive, read, or access, an original audio source input 510, and then replicate the left and right audio content channels to produce a plurality of audio content channels 511-516. Multiple high pass filters, e.g., optionally a first high pass filter 520 and a second high pass filter 525 are depicted to filter or attenuate the bass frequencies from the original audio source content channels 511, 512, 515, 516. The high frequency stream content channels 521, 522 generated from the first high pass filter 520, may optionally be down-mixed via a down mix stage 544 by being passed through a down-mixer 546, e.g., a down-mixer, configured for a 2:1 ratio, thereby generating a down-mixed stream content 547. The generated down-mixed stream content 547 may then be transmitted using the on-display spatialization based on the state of the video display 560. The second high pass filter 525 is depicted as operating on the original audio content channels 515, 516 generating high frequency stream channels 526, 527. The high frequency stream channels 526, 527 are then passed through an inverter 530. The inverted stream content channels 531, 532 are then added 535, 540 to the original audio stream contents 513, 514, generating low frequency stream content channels 541, 542. The low frequency stream content channels 541, 542 may also be optionally passed through a 2:1 down-mixer 548 creating a down-mixed stream content 549 before being transmitted 550 to a loud speaker.

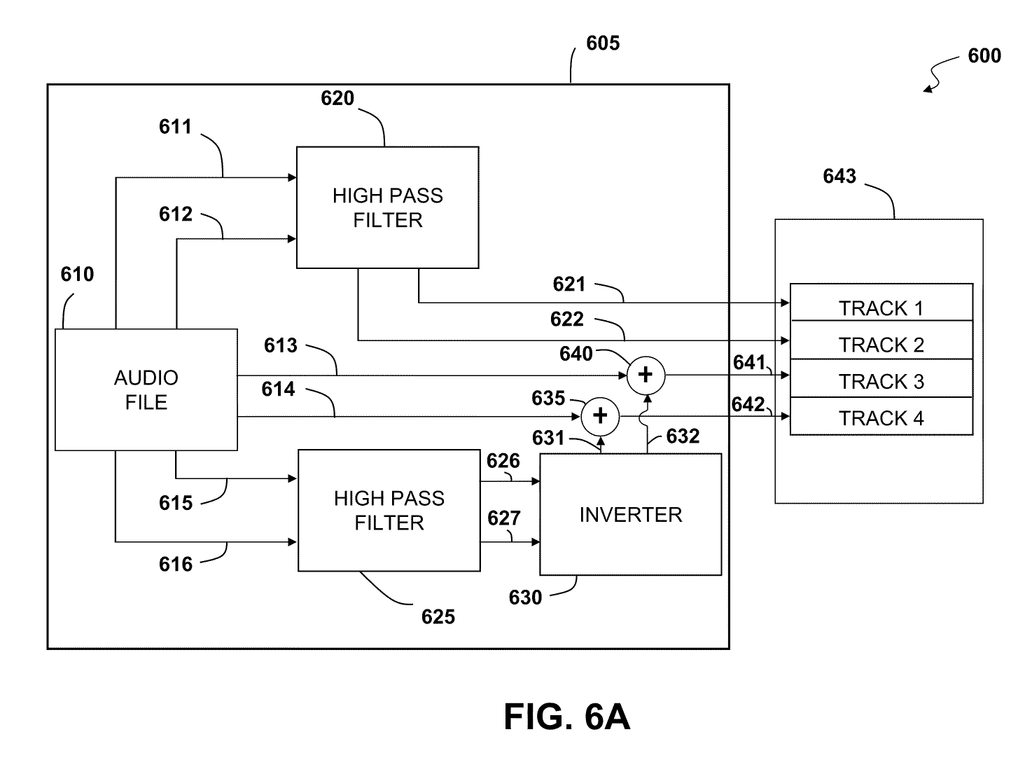

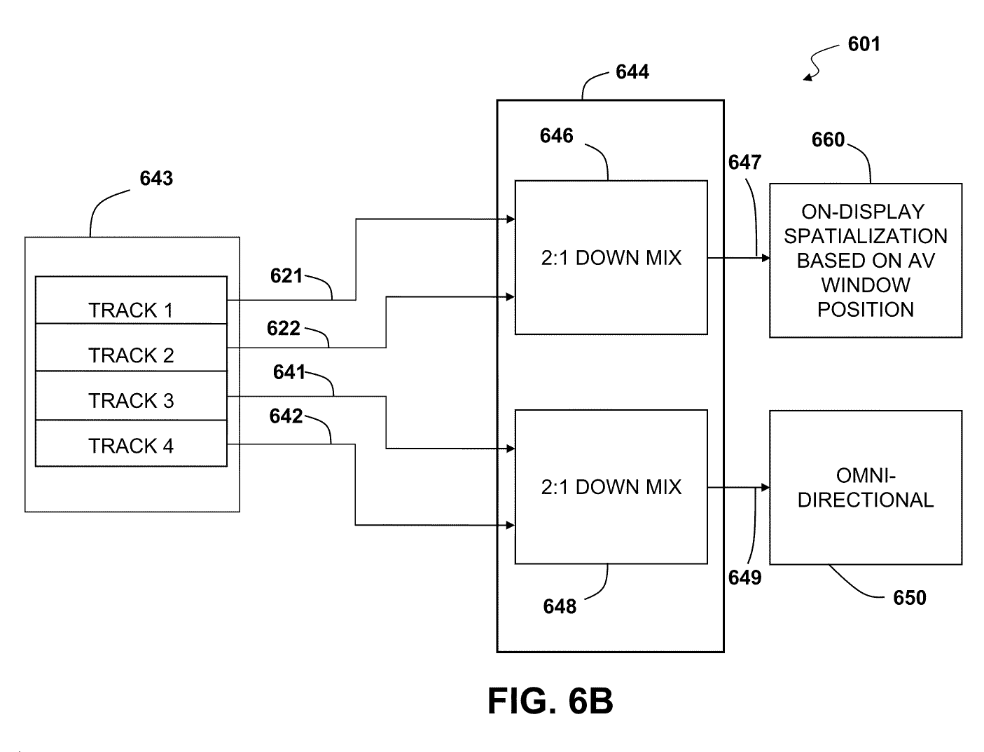

FIG. 6A depicts in an exemplary functional block diagram a multiple channel, e.g., left and right channel, frequency separation-content storage stage 600. The frequency separation stage 605 may receive, read, or access an original audio source input 610. The frequency separation stage is depicted as configured to replicate the audio content channels to produce a plurality of stream channels 611-616. Optionally, two or more high pass filters, e.g., a first high pass filter 620 and a second high pass filter 625, may perform the filtering or attenuation of the bass frequencies from the original audio source content channels 611, 612, 615, and 616. The first high pass filter 620 is depicted as operating on the original audio content channels 611, 612 thereby generating high frequency stream channels 621, 622. In a similar fashion, the second high pass filter 625 is depicted as operating on the original audio content channels 615, 616—thereby generating high frequency stream channels 626, 627. The high frequency stream channels 626, 627 may then passed through an inverter 630. The inverted stream content channels 631, 632 may then added 635, 640 to the original audio stream contents 613, 614, generating low frequency stream content channels 641, 642. The high frequency stream content channels 621, 622 that are generated from the first high pass filter 620, along with the low frequency stream content channels 641, 642 may optionally be stored as an off-line pre-processing stage 643 wherein a plurality of tracks are stored, e.g., in tracks 1-4. In one embodiment, a custom storage format, e.g., WAV file format, may be applied for storing the frequency separated audio content channels independently from video frames. In another embodiment a custom storage format, e.g., AVI/MP4 file format, may be applied for storing the frequency separated audio content channels together with the video frames for the content.

In FIG. 6B the exemplary functional block diagram is depicted as an embodiment of a post-storage frequency separation-content storage stage 601. The high frequency stream content channels 621, 622, generated from the first high pass filter 620 (FIG. 6A), may optionally be down-mixed at a down-mixer stage 644 by being passed through a down-mixer 646, e.g., at a 2:1 ratio, thereby generating a down-mixed stream content 647. The down-mixed stream content may be transmitted using the on-display spatialization based on the state of the video display 660. Optionally, the low frequency stream content channels 641, 642 may be passed through a down-mixer 648, e.g., at a 2:1 ratio, thereby creating a down-mixed stream content 649 before being transmitted to create an omni-directional spatialization 650.

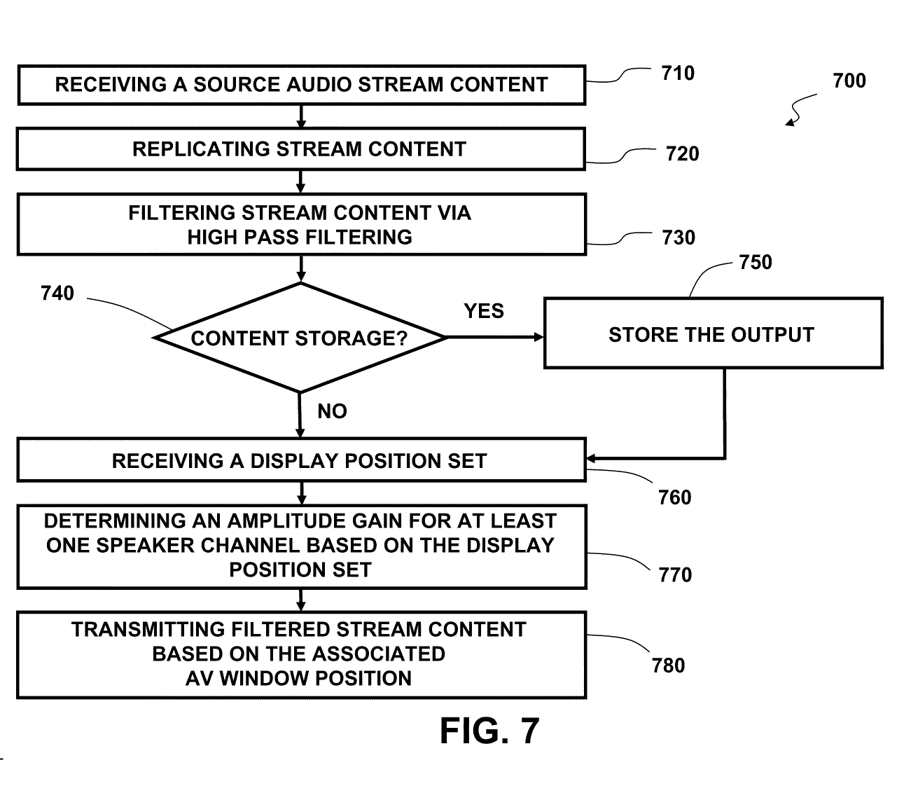

FIG. 7 is a flowchart depicting an exemplary process 700 of the audio spatialization and frequency separation system or device further including storing the content stream. The source audio stream content (step 710) may be provided to the system or device by optionally receiving, reading or accessing the original audio input. The audio stream content may be replicated (step 720). The audio stream content may be passed through a high pass filter or otherwise subject to high pass filtering and/or low frequency attenuating (step 730), e.g., a bass removal filter that passes the high frequency stream content. If content storage is available (test 740), then the output may be stored (step 750). The output may be subsequently read from the memory during a non-real-time spatialization step. The information containing the display position set is thereafter depicted as being received (step 760), e.g., AV window position information. An amplitude gain based on the display position set is determined (step 770) for at least one speaker channel. In this exemplary embodiment, the frequency separation stage may be applied as an off-line preprocessing stage. The filtered stream content may then be transmitted based on the associated AV window position (step 780) to at least one or a plurality of loud speakers. If content storage is not available or its use otherwise precluded, then the output may be transmitted to a plurality of loud speakers directly.

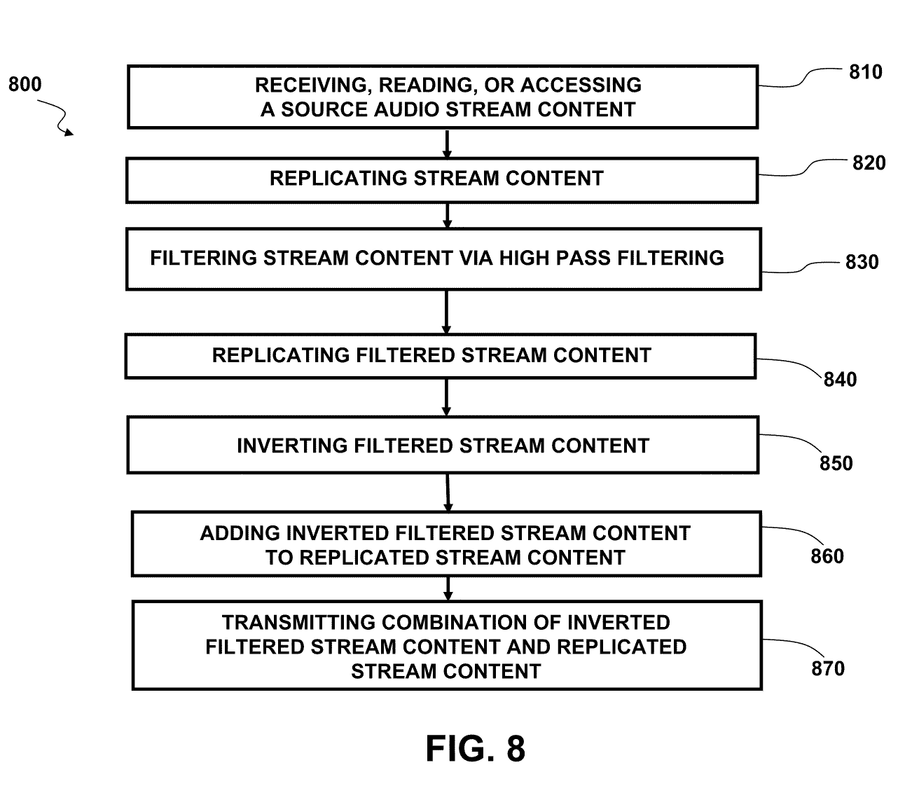

FIG. 8 is a flowchart depicting an exemplary process 800 of the audio spatialization and frequency separation system or device. The source audio stream content (step 810) is provided to the system by optionally receiving, reading or accessing the original audio input. Accordingly, the audio stream content may be replicated (step 820) thereby having a plurality of the same stream content. The audio stream content is depicted as passing through a high pass filter (step 830) or otherwise subject to high pass filtering and/or low frequency attenuating, e.g., a bass removal filter, which passes the high frequency stream content. The filtered stream content that is a high frequency stream content may then be replicated (step 840). The filtered high frequency stream content is inverted (step 850) and added to the replicated stream content (step 860) to create the complement of the low frequency stream content, for this example. The combination of the inverted filtered stream content and the replicated stream content, which is the low frequency content, may then be transmitted (step 870) to a loud speaker.

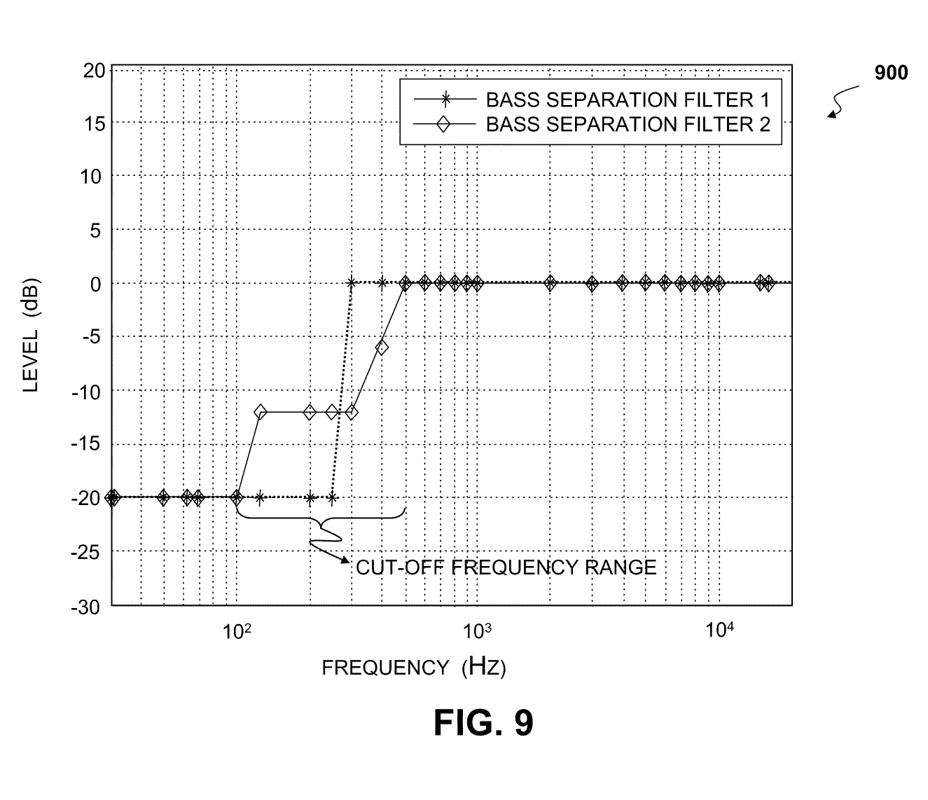

FIG. 9 shows the frequency response in an exemplary system 900 using two different bass removal filters, where the filters may be similarly applied in removing or attenuating the bass frequencies. Separation filter 1 depicts a cut-off frequency of approximately 250 Hz. Separation filter 2 depicts a cut-off frequency of approximately 200-400 Hz as shown in the cut-off frequency range of FIG. 9.

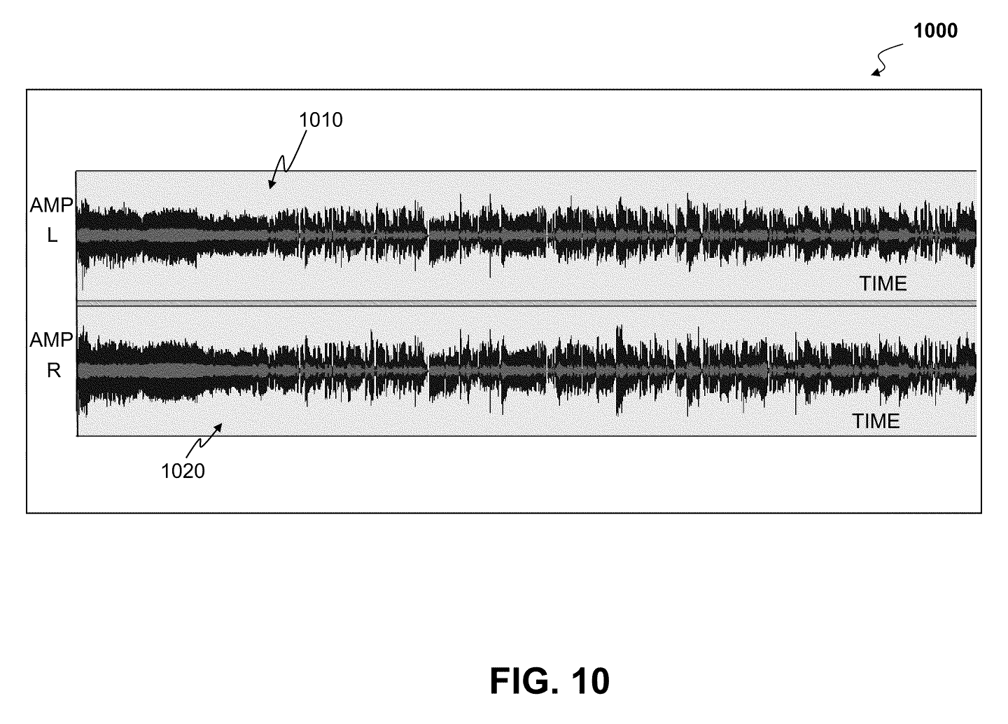

FIG. 10 shows the amplitude versus time plot 1000 for an exemplary original stereo content with two audio channels, e.g., left channel 1010 and right channel 1020, for this example.

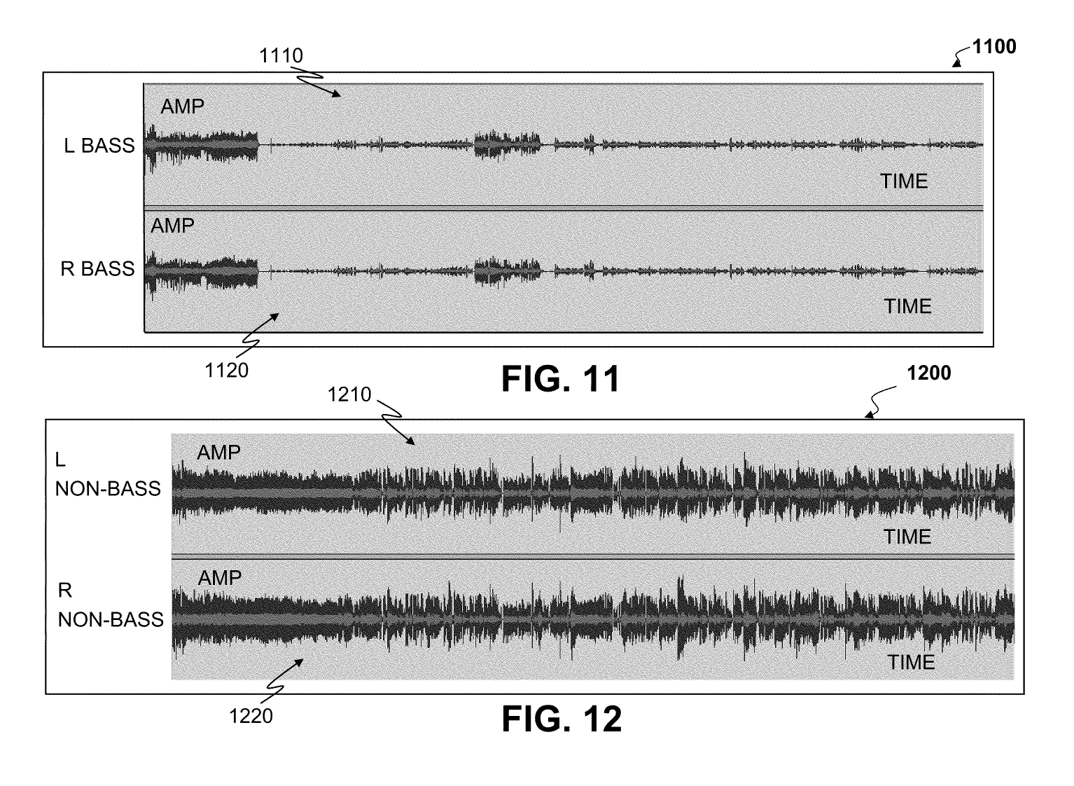

FIG. 11 shows an exemplary amplitude versus time plot 1100 of the bass frequencies for the audio content, e.g., left bass channel 1110 and right bass channel 1120, for this example. The output of the frequency separation stage is depicted as utilizing the bass removal filter in FIG. 9, particularly bass separation filter 2, which is an exemplary amplitude plot, for this example.

FIG. 12 shows an exemplary amplitude versus time plot 1200 of only the non-bass frequencies for the audio content, e.g., left non-bass 1210 and right non-bass 1220, for this example.

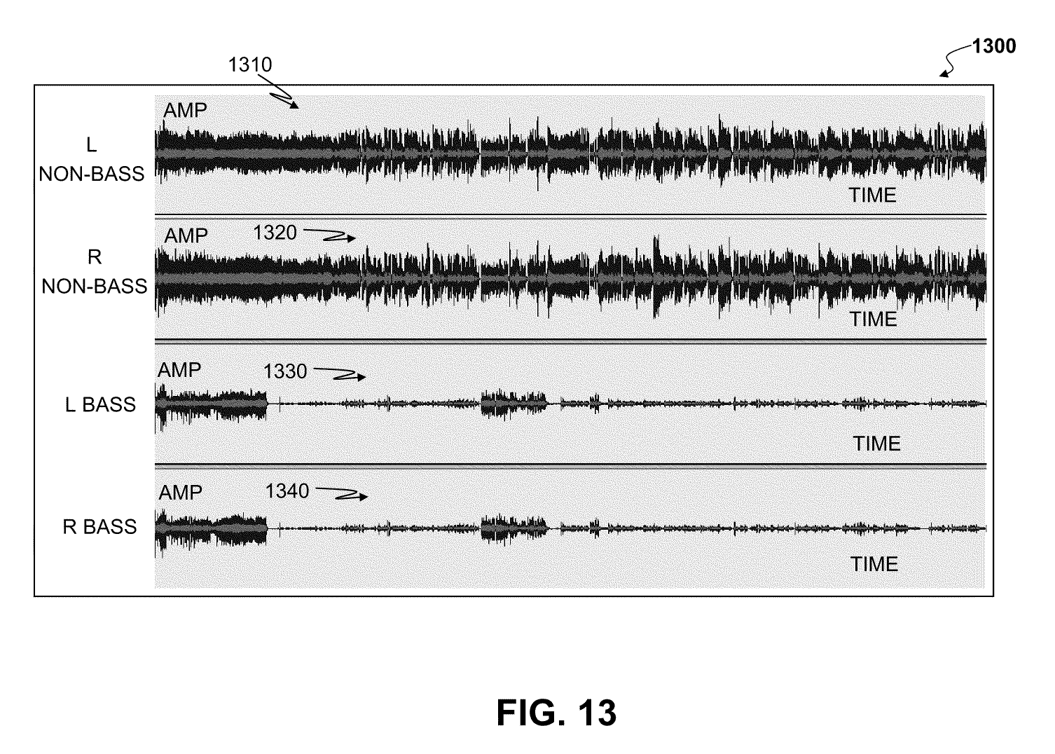

FIG. 13 shows an example of four output audio channels 1300 generated from the exemplary frequency separation stage. Included are two non-bass frequency channels, e.g., left non-bass 1310, right non-bass 1320; and two bass frequency channels, e.g., left bass 1330 and right bass 1340, all stored in a custom file format, e.g., WAV file format.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention is herein disclosed by way of examples and should not be limited by the particular disclosed embodiments described above.

What is claimed is:

1. A method comprising:
filtering a stream content; and
transmitting the filtered stream content via a plurality of speaker channels, wherein at least one of the speaker channels of the plurality of speaker channels comprises an amplitude gain based on a display position set.

2. The method of claim 1 further comprising at least one of: receiving, reading, and accessing a source stream content.

3. The method of claim 1 wherein the stream content comprises audio content.

4. The method of claim 1 wherein the transmitted filtered stream content comprises high frequency stream content.

5. The method of claim 4 wherein the high frequency stream content is transmitted to a plurality of loud speakers proximate to a video display.

6. The method of claim 1 further comprising:
generating an inversion of the filtered stream content;
combining the inverted filtered stream content with the stream content; and
transmitting the combination of the inverted filtered stream content and the stream content.

7. The method of claim 6 wherein the filtered stream content of at least one of the speaker channels of the plurality of speaker channels is stored in a custom file format.

8. The method of claim 6 wherein the transmitted combination of the inverted filtered stream content and the stream content comprises low frequency stream content.

9. The method of claim 8 wherein the low frequency stream content is transmitted to a loud speaker.

10. The method of claim 8 wherein the low frequency stream content is transmitted to an omni-directional speaker.

11. A computing device comprising:
a processor, and a memory comprising a set of one or more amplitude gains associable with a display position set, wherein the processor is configured to:
filter a stream content; and
transmit the filtered stream content via a plurality of speaker channels, wherein at least one of the speaker channels of the plurality of speaker channels comprises an amplitude gain, of the set of one or more amplitude gains, based on the display position set.

12. The computing device of claim 11 wherein the processor is further configured to perform at least one of: receive, read, and access a source stream content.

13. The computing device of claim 11 wherein the stream content comprises audio content.

14. The computing device of claim 11 wherein the transmitted filtered stream content comprises high frequency stream content.

15. The computing device of claim 14 further configured to transmit the high frequency stream content, each via a speaker channel of the plurality of speaker channels, to a plurality of loud speakers proximate to a video display.

16. The computing device of claim 11 wherein the processor is further configured to:
generate an inversion of the filtered stream content;
combine the inverted filtered stream content with the stream content; and
transmit the combination of the inverted filtered stream content and the stream content.

17. The computing device of claim 16 wherein the at least one of the speaker channels of the plurality of speaker channels is stored in a custom file format.

18. The computing device of claim 17 wherein the transmitted combination of the inverted filtered stream content and the stream content comprises low frequency stream content.

19. The computing device of claim 18 further configured to transmit the low frequency stream content to a loud speakers.

20. The computing device of claim 18 further configured to transmit the low frequency stream content to an omni-directional speaker.

21. A computer-readable non-transitory medium having computer-executable instructions stored thereon which, when executed by a computer, configure the computer to:
filter a stream content wherein the stream content comprises audio content;
transmit the filtered stream content via a plurality of speaker channels, wherein at least one of the speaker channels of the plurality of speaker channels comprises an amplitude gain based on a display position set;
generate an inversion of the filtered stream content;
combine the inverted filtered stream content with the stream content; and
transmit the output of the combination of the inverted filtered stream content and the stream content.
